(19) United States
(12) Patent Application Publication
(10) Pub. No.: US 2004/0012689 A1
(43) Pub. Date: Jan. 22, 2004

(54) Charge coupled devices in tiled arrays

(75) Inventors: Natale F. Tinnerino, Morgan Hill, CA (US); Jose Camara, Saratoga, CA (US); Edward LeonGuerrero, Union City, CA (US); Harlan Lawler, Milpitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Fairchild Imaging, Milpitas, CA

(21) Appl. No.: 10/197,968

(22) Filed: Jul. 16, 2002

(51) Int. Cl. H04N 5/335

(52) U.S. Cl. 348/218.1

(57) ABSTRACT

Charge coupled devices (CCDs) can be placed next to each in a tiled array to reproduce a larger image. The seams between the CCDs in a tiled CCD array can be reduced by placing fiber optic arrays on top of each CCD in the CCD array. The fiber optic arrays have numerous optical fibers that are tilted with respect to the plane of the CCDs. The optical fibers can retrieve electromagnetic radiation falling in gaps between the tiled CCDs. The optical fiber arrays substantially reduce the seams that appear in the image. Electronic pixel binning configurations can be adjusted to accommodate the placement of the optical fibers. The fiber optic arrays can have beveled edges near the gaps between adjacent CCDs to image light in the gaps. Techniques for reducing the dead zone between CCDs in a tiled array and for forming fiber optic arrays on a common plane are also provided.

### BACKGROUND OF THE INVENTION

The present invention relates to an imaging device formed with an array of charge coupled devices, and more particularly, to an imaging device in which the thickness of the seams between the charge coupled devices are reduced. The present invention also relates to the assembly of imaging devices that comprise tiled arrays of charge coupled devices.

Charge coupled devices (CCDs) are made up of contiguous photodetecting picture elements (pixels) formed on a semiconductor wafer. The pixels can detect light and output electrical signals in response to the light.

Output electrical signals are proportional to the intensity of the impinging light rays, and can be processed, digitized, stored and reconstructed to produce an image of the object. CCDs are very sensitive to light. Therefore, the image produced can be a very accurate reproduction of the object.

CCDs are usually formed on a semiconductor wafer that is a few inches in width. The small size of a typical CCD limits the light sensing area of the imaging device. It would therefore be desirable to provide an imaging device that has a larger light sensing area than a typical single CCD.

### BRIEF SUMMARY OF THE INVENTION

The present invention provides techniques for developing tiled arrays of charge coupled devices (CCDs). CCDs can be placed next to each in a tiled array to provide a larger light sensing area. Adjacent CCDs typically cannot touch each other. Therefore, spatial gaps are provided between the CCDs to protect them from damage and to provide space for headers that the CCDs are mounted on. But spatial gaps between the CCDs form seams in the output image, because the electromagnetic radiation that falls into the spatial gaps is not sensed by the CCDs.

The present invention includes techniques for reducing the seams between the CCDs that appear in the output image. Fiber optic arrays are placed above each CCD in a CCD array. The fiber optic arrays have numerous optical fibers that are tilted with respect to the plane of the CCDs so that they can capture electromagnetic radiation that would otherwise fall in the spatial gaps between the tiled CCDs. This arrangement of optical fiber arrays substantially reduces the seams that would otherwise appear in the reproduced image.

The output signals from adjacent CCD pixels can be summed together (binned) to effectively increasing the signal-to-noise ratio of the resulting output signals. The binning configurations can be adjusted to accommodate the placement of the optical fibers, in accordance with the present invention.

In another embodiment of the present invention, the fiber optic arrays can have beveled edges near the gaps between adjacent CCDs. The beveled edges allow the CCDs to collect even more of the electromagnetic radiation that falls into the gaps between the CCDs. The beveled edges produce a continuous image that has no seams between the CCDs.

In another embodiment of the present invention, the orientation of CCDs in a tiled array can be shifted with respect to each other to reduce the large dead zone that appears where the corners of four CCDs come together.

In still another embodiment of the present invention, the fiber optic arrays in a tiled CCD array can be formed on a common reference plane. The fiber optic arrays are placed on the common reference plane, and then ceramic headers that enclose the CCDs are bonded to saddles that are attached to a base plate. The thickness of the bonding layer varies to accommodate for variations in the thickness of the various fiber optic arrays in the assembly.

### BRIEF DESCRIPTION OF THE DRAWINGS

FIG. 1 illustrates an M×N array of charge coupled devices in accordance with the present invention;

FIGS. 2A-2B illustrate cross sections of first and second embodiments of imaging devices with substantially reduced seams in accordance with the present invention;

FIG. 3 illustrates a charge coupled device, a horizontal shift register, a summing well, an amplifier, and associated circuitry in accordance with the present invention;

FIG. 4 illustrates another cross section of an imaging device in accordance with the present invention;

FIG. 5 illustrates a plurality of bin configurations for pixels in a charge coupled device in accordance with the present invention;

FIG. 6 illustrates a bin configuration for pixels in the second embodiment of a seamless imaging device of the present invention;

FIG. 7 illustrates a beveled fiber optic array in accordance with the present invention;

FIGS. 8A-8B illustrate visualizations of the image obtained from sensor pixels in accordance with embodiments of the present invention;

FIGS. 9A-9B illustrate configurations of tiled charge coupled devices in accordance with another embodiment of the present invention;

FIG. 10 illustrates an exemplary CCD tile configuration in accordance with the present invention; and

FIGS. 11-12 illustrate an array of charge coupled devices that are assembled using an even reference plane in accordance with the principles of the present invention.

### DETAILED DESCRIPTION OF THE INVENTION

Charge coupled devices (CCDs) are typically formed on semiconductor wafers that may be a few inches in diameter (e.g., 5 inches). The size of a CCD wafer limits the maximum area of an image that a CCD can reproduce. But CCDs may be placed next to each other in M×N arrays as shown in FIG. 1 to create a larger area image. Thus, a plurality of smaller CCDs can be placed adjacent to each other in order to reproduce a larger image that would otherwise only be reproducible by increasing the wafer size of a single CCD. Further details of a “Large Area Charge Coupled Device Camera” are discussed in U.S. patent application Ser. No. ______ (Attorney Docket Number 013843-003500US), to Natale Tinnerino, filed concurrently herewith, which is incorporated by reference herein.

For example, FIG. 1 illustrates four CCDs 101-104 arranged in a 2×2 array. Other CCD array patterns may be chosen. For example, a CCD array may comprise a 2×3 array, a 2×4 array, a 4×4 array, a 2×6 array, etc.

If the edges adjacent to the active area of the global change CCDs touch each other when placed in an M×N array, the CCDs may become damaged. Also, the imaging area does not extend to edge of CCD, because pixels near the edge of the CCD may not receive enough electromagnetic radiation to form a portion of an image. Therefore, a spatial gap (e.g., gap 105) is formed between the edges of each CCD.

However, when an image is formed from light impinging on a M×N CCD array with gaps, the light that falls into the gaps is lost. As a result, the image appears with discontinuities due to the seams or gaps between the CCD tiles. The seam that forms between tiles in a CCD array can be reduced or eliminated by using a number of techniques in accordance with the present invention. These techniques are discussed in further detail next.

FIG. 2A illustrates a cross section of a first embodiment of an imager 110 in accordance with the present invention. Imager 110 includes CCDs 124 and 125. Each of CCDs 124 and 125 includes a plurality of rows and columns of pixels. Only one row of pixels is shown in FIG. 2A for simplicity. The pixels are assigned integer numbers from 0 to 8 in FIG. 2A. CCDs 124 and 125 are placed in headers 121 and 122, respectively, for support. Headers 121 and 122 may comprise ceramic or other material. The spatial gap between the CCDs also provides room for headers 121-122.

Optical fiber array 131 is placed above CCD 124 and a portion of header 121, and optical fiber array 132 is placed above CCD 125 and a portion of header 122, as shown in FIG. 2A. Arrays 131 and 132 also serve to protect CCDs 124 and 125 from impinging X-Rays that might damage the CCDs. Scintillator 110 is placed over optical fiber arrays 131 and 132. Scintillator 111 may comprise any type of scintillator material (e.g., cesium iodide).

The edges of arrays 131 and 132 do not touch each other. If arrays 131 and 132 contact each other, the optical fibers could chip. Therefore, there is a small air gap or shim between the inner edges of arrays 131 and 132, as shown in FIG. 2A.

Optical fiber array 131 includes numerous parallel optical fibers 115 that extend from one surface of the array to another. Optical fiber array 132 also includes numerous parallel optical fibers 116 that extend from one surface the of the array to another. Optical fibers 115 are tilted at an angle that is less than 90° with respect to the plane of CCD 124, and optical fibers 116 are tilted at an angle that is greater than 90° with respect to the plane of CCD 125, as shown in FIG. 2A.

Radiation from an x-rayed object impinges upon the upper surface of scintillator panel 111. Scintillator 111 coverts the radiation into longer wavelength electromagnetic radiation. For example, the electromagnetic radiation from scintillator 111 may comprise visible light, infrared light, and/or ultraviolet light. In a further embodiment, scintillator 111 may be removed, and light from on object can directly enter the optical fibers (instead of using x-rays). In this embodiment, the scintillator is not needed to convert the incoming light to a longer wavelength.

The electromagnetic radiation from scintillator 111 enters optical fibers 115 and 116. Optical fibers 115 and 116 conduct electromagnetic radiation (e.g., light). The electromagnetic radiation travels through optical fibers 115 and 116 to CCDs 124 and 125.

One or more of optical fibers 115 and 116 falls on each pixel in CCDs 124 and 125. Pixels in the CCDs are sensitive to particular wavelengths of electromagnetic radiation. For example, CCDs may be sensitive to visible light, infrared light, and/or ultraviolet light. The pixels sense electromagnetic radiation in a range of wavelengths provided by the optical fibers. A pixel outputs an electrical signal in response to the intensity of electromagnetic radiation received through the optical fiber. The term “light” as used herein is used for simplicity and is not intended to be limited to visible light.

After exposure, signals from the pixels are temporarily stored in vertical shift register elements (not shown) in the semiconductor wafer. CCDs 123 and 125 may, for example, comprise interline transfer CCDs. Interline transfer CCDs have columns of vertical shift registers that are interleaved in between the columns of pixels. Each column of pixels is adjacent to a column of vertical shift registers. The signals from the pixels do not have to travel far to be stored in the vertical shift registers in interline transfer CCDs. This configuration helps to increase the data transfer rate of CCDs. Further details of “Large Area, Fast Frame Rate CCDs” are discussed in U.S. patent application Ser. No. ______ (Attorney Docket Number 013843-003200US), to Wen et al., filed concurrently herewith, which is incorporated by reference herein.

Subsequently, the pixel signals are read out from the CCD, processed and transmitted to the image reconstruction circuitry (not shown). The image reconstruction circuitry reconstructs the pixel signals into image data signals raster formatted to display a reproduction of the image on a display screen for viewing. Further details of exemplary image reconstruction circuitry are discussed in “Image Reconstruction Techniques for CCDs”, U.S. patent application Ser. No. ______ (Attorney Docket Number 013843-004200US) to Natale Tinnerino, filed concurrently herewith, which is incorporated by reference herein.

Line 117 extends to the upper right corner of fiber optic array 131. The light rays entering the optical fibers 115 that are to the left of line 117 reach pixels designated 4, 5, 6, 7, or higher in CCD 124.

Little or no light from scintillator 111 travels through optical fibers 115 that are to the right of line 117, because the ends of these optical fibers 115 are exposed along a side wall of fiber optic array block 131. In other words, optical fibers 115 to the right of line 117 map from pixels 0-3 to the side of array block 131. Therefore, the image signals from pixels 0-3 are not used to produce the final image.

Similarly, little or no light from scintillator 111 travels through optical fibers 116 that are to the left of line 118. Therefore, signals from pixels 0-2 are not used to produce the final image. Optical fibers 116 to the left of line 118 map from pixels 0-2 to the side of array block 132.

One edge of line 118 extends to the upper left corner of array 132. The light traveling through optical fibers 116 that are to the right of line 118 reaches pixels designated 3, 4, 5, 6, 7, or higher in CCD 125.

By angling optical fibers 115 and 116 within arrays 131 and 132 as shown in FIG. 2A, the seams in the image caused by the gaps between the CCDs (such as gap 105 in FIG. 1) are significantly narrowed to the minimum spacing 119 between fiber optic arrays. The optical fibers to the left of line 117 in array 131 and to the right of line 118 in array 132 partially capture light from scintillator 111 above gap 119.

Without arrays 131 and 132 the light exiting scintillator 111 in gap 120 between CCDs 124 and 125 would not be sensed by the CCDs. However, with arrays 132 and 132 present, only the small amount of light that exits scintillator 111 in gap 119 is not sensed by CCD sensors 124 and 125. Thus, the seam that shows up in the image outputted from CCD sensors 124 and 125 is significantly reduced, because much less of the light falling between the CCD sensors is lost in imager 110.

FIG. 2B illustrates a cross section of a second embodiment of a CCD imager in accordance with the present invention. Scintillator 321 lies on top of fiber optical arrays 325 as shown in FIG. 2B. Fiber optic arrays 325 are placed on top of CCD chips such as CCD 322. The CCD chips are attached to headers such as header 323.

Fiber optic arrays 325 each contain a plurality of tapered optical fibers. Each optical fiber transmits electromagnetic radiation from scintillator 321 to one or more pixels in one of the CCDs.

The tapered optical fibers in the fiber optic arrays 325 fan out from the CCDs to scintillator 321. The optical fibers around the edges of fiber optic arrays 325 bend away from a center axis of fiber optic arrays 325 above the surfaces of the charge coupled devices as shown in FIG. 2B.

The fiber optic arrays 325 capture most of the light from scintillator 321 that would otherwise fall into the spatial gaps between the CCDs, as with the previous embodiment. Therefore, fiber optic arrays 325 also substantially reduce the seams that appear in an image formed from a CCD array.

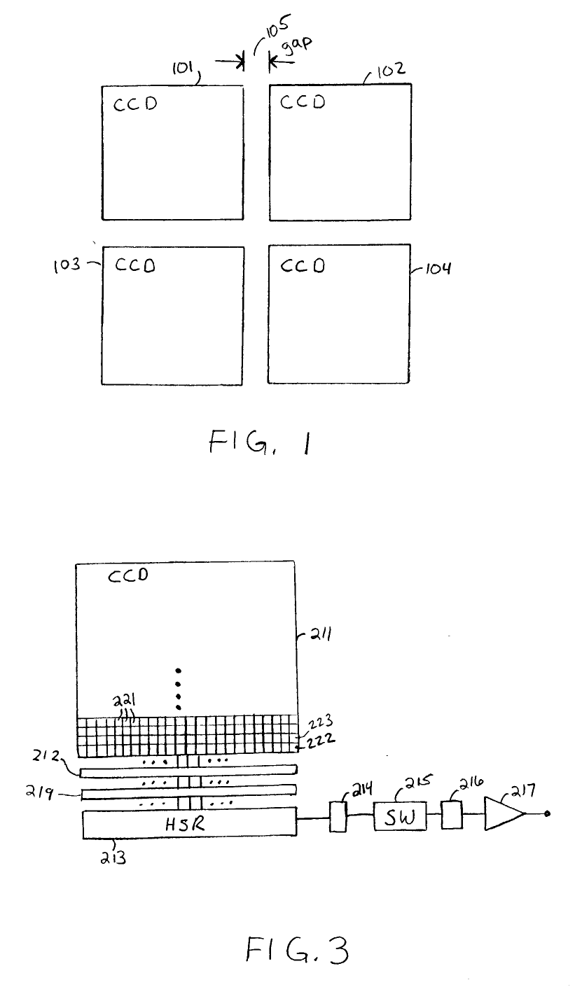

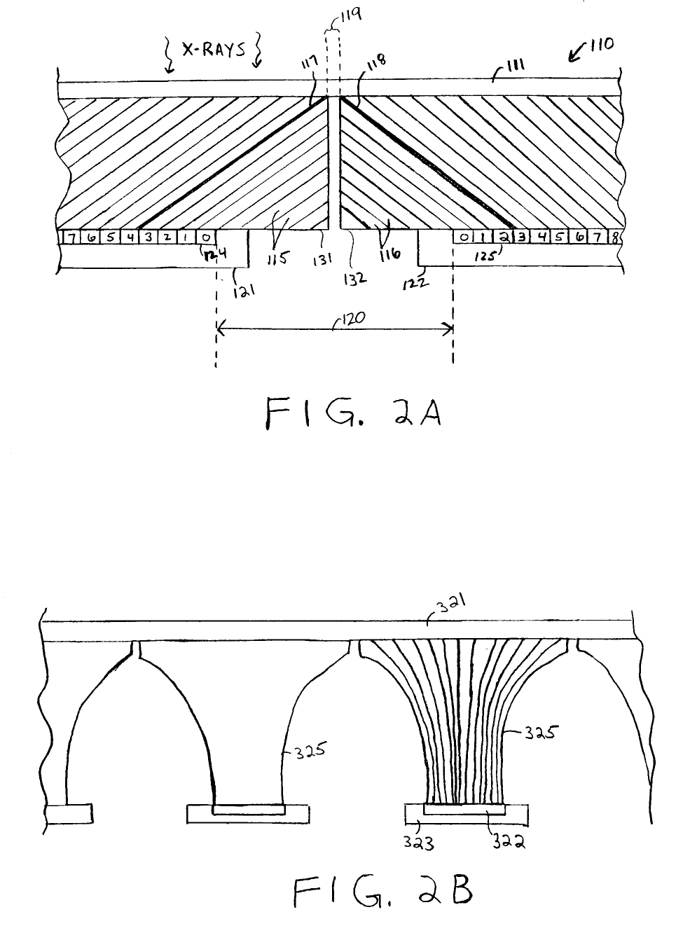

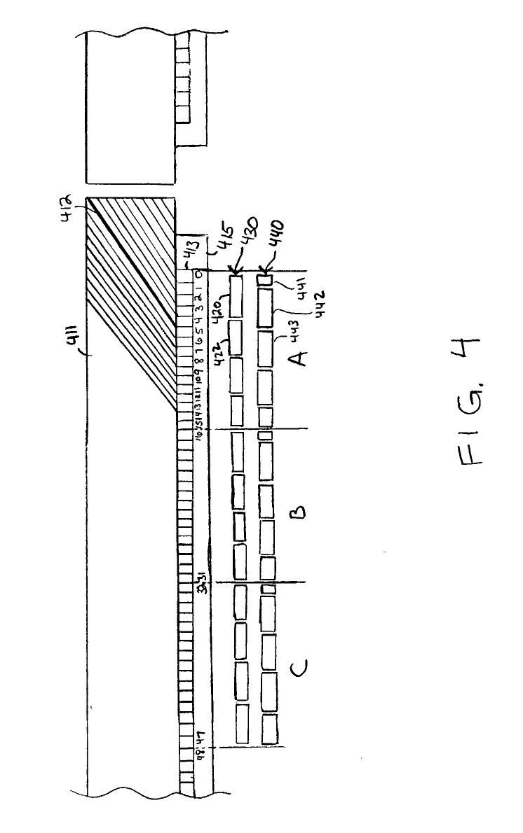

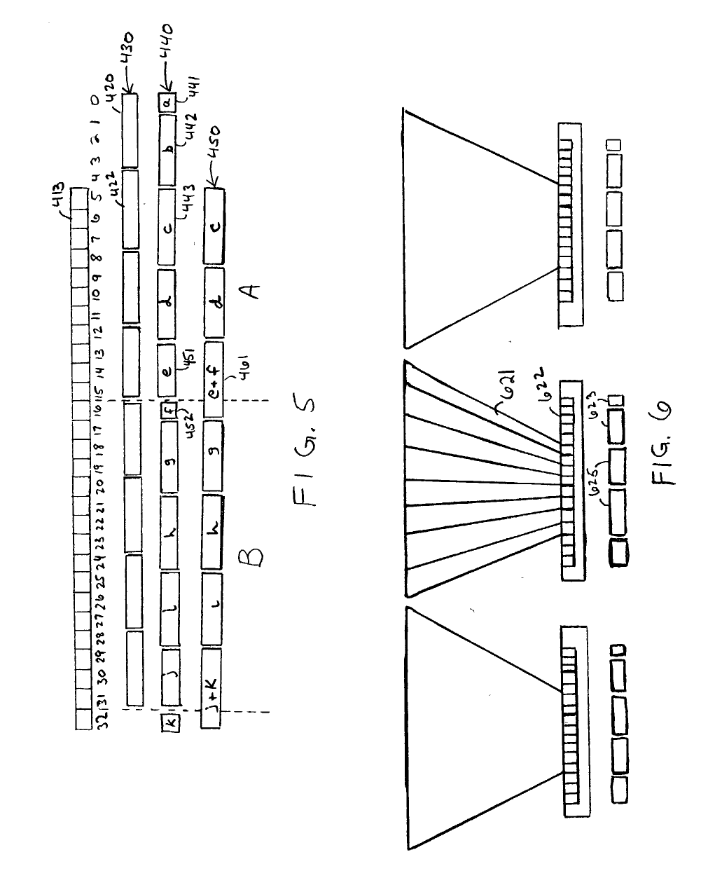

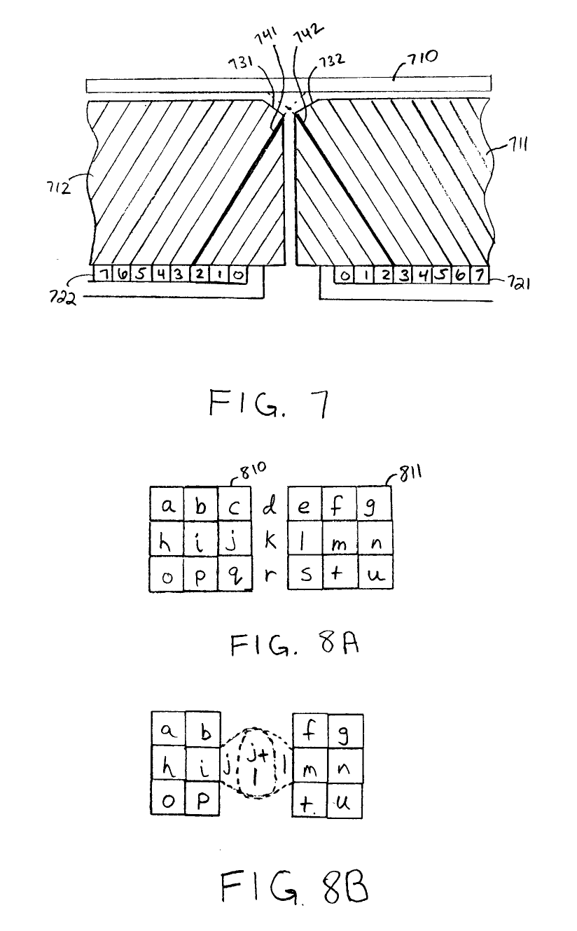

FIG. 3 illustrates a CCD 211 and the integrated circuitry used to transfer charge out of CCD 211. CCD 211 includes a plurality of pixels 221 and adjacent storage sites forming vertical shift registers (not shown). Pixels 221 are arranged in a plurality of rows and columns. For example, a CCD may include 2048 rows and 2048 columns of pixels and adjacent storage sites.

The circuitry shown in FIG. 3 includes a plurality of parallel transmission gates 212, vertical summing wells 219, horizontal shift registers 213, transmission gate 214, horizontal summing well 215, transmission gate 216, and buffer circuit 217. Each transmission gate 212 is coupled to one of the columns of pixels and to one of horizontal shift registers 213.

The pixels in a CCD may be divided into a number of channels. For example, a CCD with 2048 columns of pixels may be divided into 8 channels, with 256 columns of pixels in each of the 8 channels.

One horizontal shift register is typically coupled to receive signals from only one channel of pixels in the CCD. For example, a CCD with 2048 columns of pixels may have 8 channels and thus 8 horizontal shift registers, wherein each horizontal shift register is coupled to receive signals from 256 columns of pixels. In the example of FIG. 3, horizontal shift register 213 is coupled to 24 columns of pixels in CCD 211 through transmission gates 212.

When electromagnetic radiation in a particular range of wavelengths impinges upon pixels 221, pixel signals representing image data are formed in semiconductor regions associated with the pixels. Vertical shift registers (not shown) associated with each column of pixels are used to transfer the pixel signals out of CCD 211 and into vertical summing wells 219.

The opening and closing of transmission gates 212 are controlled by one or more clock signals. Transmission gates 212 allow pixel signals in the last row 222 of pixels to be transferred to vertical summing wells 219. At the same time, the pixel signals in the second to last row 223 of pixels are transferred to row 222 using the vertical shift registers. In this manner, all rows of pixel signals are simultaneously shifted down on row using the vertical shift registers.

In the next cycle, the pixel signals transferred to row 222 from row 223 in the previous cycle are then transferred to vertical summing wells 219, and simultaneously the pixel signals in the other rows shift down one row.

More than one row of pixel signals may be summed together in an analog fashion in vertical summing wells 219. This technique is called binning. For example, pixel signals originally from row 223 may be summed with charge signals originally from row 222 in vertical summing wells 219. In an alternative embodiment, vertical summing wells 219 can be eliminated and signals from multiple rows of pixels are summed together in horizontal shift registers (HSR) 213.

Each of the pixel signals from row 223 is added to a pixel signal from row 222 that is in the same column. Alternatively, pixel signals from three, four, or more rows of pixels can be summed together in vertical summing wells 219 or HSR 213. Each pixel signal is added to pixel signals from other rows in the same column of pixels. If vertical summing wells 219 are used, the summed pixel signals are subsequently stored in HSR 213.

The summed charge signals are then shifted out of HSR 213 into horizontal summing well (SW) 215. Transmission gate 214 controls how many columns of pixel signals are transferred into horizontal summing well 215. The opening and closing of transmission gate 214 is controlled by one or more clock signals. Clock signals also control the shifting of charge signals across horizontal shift registers 213.

Pixel signals from multiple columns of pixels can be added together (e.g., in an analog fashion) in summing well 215. This method is also part of the binning technique mentioned above. For example, transmission gate 214 can allow pixel signals from four columns of pixels to be transferred into and added together in an analog fashion in summing well 215. When transmission gate 216 opens, the summed charge signal in summing well 215 is buffered by buffer 217 and transferred to additional circuitry for further image processing.

In a 4×4 binning technique, signals from four rows of pixels are added together in HSR 213 or in vertical summing wells 219, and the summed signals from four columns of pixels are added together in horizontal summing well 215. Thus, signals from a total of 16 pixels (in 4 rows and 4 columns) are summed together in summing well 215 and then buffered by buffer 217. In a 2×2 binning technique, charge signals from 4 pixels (2 rows and 2 columns) are summed together in summing well 215.

Binning charge signals from multiple pixels in a CCD provides a way to control the resolution, to read-out images faster, to increase the strength of weak signals, and to increase the signal-to-noise ratio of the CCD output signals. However, these advantages come at the expense of reduced image resolution.

Signals from the pixels can also be binned to achieve different resolutions on different areas of a CCD. For example, 1×1 binning can be applied to signals from pixels in the center of the CCD, while 4×4 binning is applied to signals near the edges of the CCD.

Pixels in a CCD can be divided into a number of channels. The signals from the pixels in each channel can be read out and processed separately using separate circuit elements. The number of pixel signals in a CCD channel can be selected to be a multiple of the number of pixels signals summed in each bin. For example, if a channel has 1020 columns and 1020 rows of pixels, then 1×1, 2×2, 3×3, 4×4, 5×5, and 6×6 binning can be applied without having extra pixel signals left over at the ends of a channel.

On other hand, the number of pixels in a CCD channel does not need to be a multiple of the number of pixel signals summed in each bin. In this embodiment, pixel signals left over at the end of each channel are added to pixel signals from an adjacent channel to complete the bin. For example, for CCD channel with 256 columns of pixels, 1 pixel signals is left over at the end of the first channel using 3×3 binning. This extra pixel signal can be added to the first two columns of pixel signals in the next adjacent channel. Further details of a “CCD Sensor with Variable Resolution” are discussed in U.S. patent application Ser. No. ______ (Attorney Docket Number 013843-003700US), to Jose Camara, filed concurrently herewith, which is incorporated by reference herein.

Image data can be extracted from cameras using binning techniques in accordance with the present invention. FIG. 4 illustrates an imaging device in accordance with the present invention that has a CCD 413 coupled to an array of optical fibers 411. Array 411 has a plurality of optical fibers including optical fiber 412. CCD 413 has a plurality of rows and columns of pixels. Only one row of pixels is shown in FIG. 4 for simplicity. Each pixel in the row is assigned an integer number in FIG. 4. CCD 413 is attached to header 415. The scintillator is not shown in FIG. 4 for simplicity.

The pixels in CCD 413 are grouped into a plurality of channels. Each channel contains a fixed number of pixel columns. For example, in the embodiment of FIG. 4, channels A, B, and C each contain 16 columns of pixels.

FIG. 4 illustrates rows 430 and 440 of blocks. The blocks correspond to signals from pixels that are summed together in the summing wells. For example, block 420 in row 430 represents a signal that is the summation of signals from pixels 0-3 in CCD 413.

Each of the blocks in row 430 is a representation of a signal that is the summation of 4 columns of pixel signals (e.g., using 4×4 binning). The 16 columns of pixels in each channel may be grouped into four “bins” with 4 columns of pixels summed together in each bin. The blocks in row 430 represent signals from the four bins in each channel, with 4 pixel columns in each bin.

One end of optical fiber 412 is exposed at the upper right corner of array 411 as shown in FIG. 4. Fiber 412 is the last fiber that is exposed at the upper surface of array 411 on its right side. Fiber 412 extends down to the edge of pixel 5 in CCD 413. Only optical fibers that are to the left of fiber 412 (including fiber 412) transmit enough light from the scintillator to provide a strong enough pixel signal. Optical fibers that are to the right of fiber 412 in FIG. 4 transmit little or no light from the scintillator.

Because little or no light from the scintillator reaches pixels 0, 1, 2, 3, and 4 in CCD 413 (relative to the higher numbered pixels), the image data in the first bin 420 of pixels is not used. Bin 420 includes pixels 0-3. In addition, the image data in bin 422 is distorted, because bin 422 includes pixel 4, which receives little or no light from the scintillator.

Binning techniques can be modified according to the principles of the present invention to eliminate bins that do not contain useful image data. For example, as shown by the binning configuration in row 440, bins containing charge signals from pixels 0-4 are eliminated, without eliminating charge signals from pixels 5 and up.

The signal from pixel 0 can be clocked into and out of summing well 215 (FIG. 3) without being added to charge from any of the other columns of pixels. Therefore, the charge signal to pixel 0 is placed in a bin 441 by itself. The signal from bin 441 is discarded by other circuitry in the imager and is not used in the active image.

The four charge signals received from pixels 1-4 are summed together in summing well 215 (FIG. 3) to form bin 442. Bin 442 does not contain useful image data, because pixels 0-4 receive light from the side edge of fiber optic array 411. Therefore, circuitry in the imager discards the first two signals from bins 441 and 442 that are outputted by amplifier 217 (FIG. 3). These two signals are not used to produce the final image. The circuitry can be pre-configured to always discard signals received from pixels 0-4.

In another embodiment, the circuitry can measure the intensity of signals from the pixels. If the signal from a pixel is less than a selected threshold level, then the signal is discarded based on the assumption that not enough light from the scintillator impacts that pixel. If the signals from a pixel is greater than the selected threshold level, then the signal is used to process the final image.

FIG. 5 illustrates further improvements in the binning techniques in accordance with the present invention. Row 450 represents the bins of charge signals that are ultimately used by the imager to reconstruct the image. Rows 430 and 440 are provided for comparison only. As can be seen, bins 441-442 are discarded from row 450.

The four charge signals received from pixels 5-8 are summed together in bin 443. Bin 443 includes the sum of four rows of pixels (or 4 columns of pixels), each containing image data received directly from the scintillator. The four charge signals from pixels 9-12 are summed together in the next bin (bin d). Each of these four charge signals also contains image data received directly from the scintillator. Therefore, circuitry in the imager uses the signal from bin 443 (and all of the subsequent bins represented in row 450) in the active image.

Each channel may have any desirable number of pixels columns. For example, channels A, B, and C in FIG. 4 each have 16 columns of pixels and 4 bins in each channel. The charge signals from pixels in each channel are stored in a separate horizontal shift register and a separate summing well (not shown).

FIG. 5 illustrates how charge signals from pixels in adjacent channels can be combined using an exemplary 4×4 binning technique. Charge signals from pixels 13-15 in channel A can be added to the charge signal from pixel 16 in channel B using a 4×4 binning technique as will now be discussed.

Charge signals from pixels 13-15 are loaded into a first horizontal shift register, summed together in a first summing well, and buffered by a first amplifier. The bin for pixels 13-15 is represented by bin 451 in FIG. 5. A charge signal from pixel 16 is loaded into a second horizontal shift register, stored in a second summing well, and buffered by a second amplifier. The charge signal from pixel 16 is not summed with charge signals from any other pixels in channel B. This charge signal is represented by bin 452 in FIG. 5.

The digitized signal from pixel 16 is stored until the digitized signals from pixels 13-15 are outputted. Then, the digitized signal from pixel 16 is summed with the digitized signals from pixels 13-15 and output as a 4 pixel column bin 461. This technique can be employed in the vertical direction to sum columns of pixel signals or in the horizontal direction to sum rows of pixels signals. The same technique can be used to sum charge signals from other adjacent channels to achieve 4×4 binning (or any other binning configuration) across channels in a CCD.

FIG. 6 illustrates another embodiment of the present invention. Optical fiber array 621 comprise tapered optical fibers that are linear (unlike the bent optical fibers shown in FIG. 2B). As shown in FIG. 6, the tapered linear optical fibers in array 621 fan out from the center axis of the CCD to expand the surface area that receives electromagnetic radiation from the scintillator. However, the optical fibers in array remain straight along their entire length.

Fiber optic array 621 maps to pixels in CCD 622. Fiber optic array 621 does not provide electromagnetic radiation to some of the pixels on the outer edges of CCD 622 as can be seen in FIG. 6. Each pixel that is directly below array 621 can receive electromagnetic radiation from one or more optical fibers in the array. The lines in array 621 are shown for purposes of illustration and do not necessarily mark the boundary line between each optical fiber in the array.

The pixel columns in CCDs may be divided into a plurality of channels as discussed above. Because optical fibers in array 621 do not provide electromagnetic radiation to pixels at the outer edges of CCDs 622, electromagnetic radiation from the scintillator does not reach these pixels. Therefore, the charge signals stored in the horizontal shift registers from these pixels are discarded.

For example, charge signals from the 5 pixels at an outer edge of CCD 622 are stored in bins 623. These bins are discarded by circuitry within the imager. Charge signals stored in bins 625 contain image data and are used by the imager in the final image.

The present invention encompasses any binning configuration (e.g., 2×2, 4×4, 2×4, 3×3, 5×5, etc.). For example, in a 3×3 binning configuration, charge signals from two pixel columns that are summed together at the end of a channel can be added to the first pixel column in the next adjacent channel to obtain a 3 column charge signal bin.

In a further embodiment of the present invention, charge signals from adjacent CCDs in a CCD array can be summed together using a binning technique. For example, in a 4×4 binning arrangement, charge signals from three columns of pixels that are summed together at the edge of one CCD can be added to a charge signal from the first column of pixels in the next adjacent CCD to obtain a 4 column charge signal bin.

If a number of pixels left at the end of a CCD or a CCD array is less than the binning requirement, charge signals from these pixel can be discarded. For example, if there are three pixels left at the end of CCD array and 4×4 binning is used, charge signals from these last 3 pixels can be discarded even if they contain image data.

Referring back to FIGS. 2A and 2B, fiber optic arrays 131 and 132 in FIG. 2A (as well as arrays 325 in FIG. 2B) do not touch each other. A gap is placed in between the fiber optic arrays so that the fibers do not get chipped and to account for process variations, which can cause misalignments in the spacing between the fiber optic arrays.

A small amount of light exiting the scintillator falls into the gap between the fiber optic arrays and does not get picked up by the CCD sensors. Therefore, a small amount of light from the image is lost when using the imager of FIG. 2B. This light loss appears as a small seam in the reconstructed image between the CCD tiles.

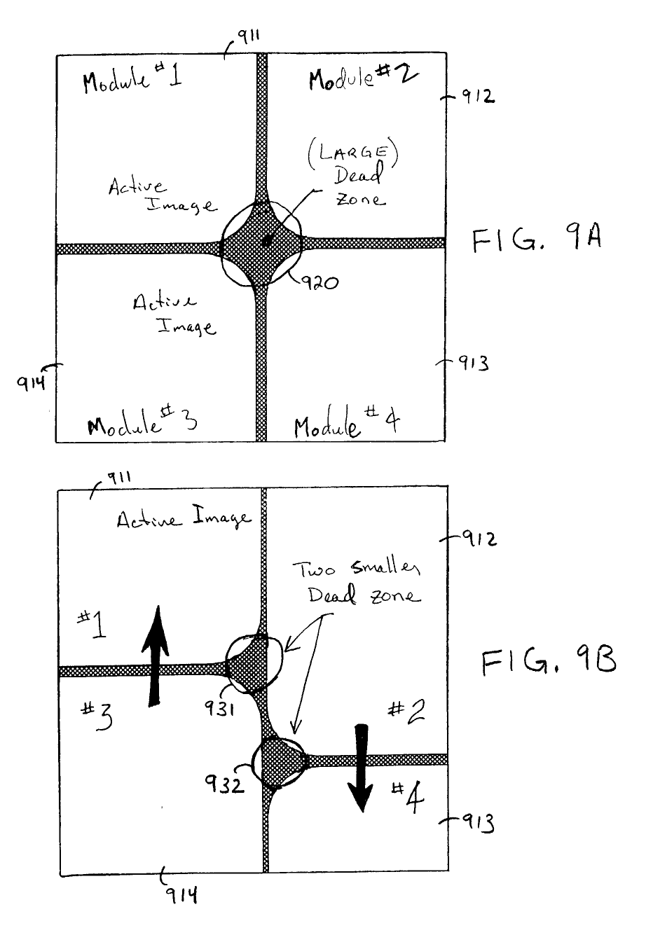

FIG. 8A illustrates a visualization of the light loss that occurs as a result of the gap between the fiber optic arrays. Squares labeled a through u represent packets of light that exit the scintillator. The packets of light that fall on one of squares 810 or 811 are sensed by the CCDs. These packets of light are used to generate the final image.

However, packets of light d, k, and r fall in the gap between the fiber optic arrays. These packets of light are not used to generate the final image, because they are not picked up by the optical fibers. In another embodiment of the present invention, the edges of the fiber optic arrays discussed above can be beveled to allow a substantial amount of the light produced at or near the gap between the fiber optic arrays to be collected.

FIG. 7 illustrates this embodiment of the present invention. FIG. 7 illustrates an imaging device that includes scintillator 710, fiber optic arrays 711-712, and CCDs 721-722. Fiber optic array 711 has a beveled corner 732, and fiber optic array 712 has a beveled corner 731. The optical fibers in arrays 711-712 that are exposed in beveled areas 731-732 receive the light in the gap at an angle and map to imaging pixels in CCD sensors 721-722.

Light exiting scintillator 710 (including light corresponding to the gap area) enters optical fibers in arrays 711-712 at beveled edges 731-732 and travels through the optical fibers to pixels in CCDs 721-722. Lines 741 and 742 mark the boundary between the optical fibers that receive light from scintillator 710 and those that do not. By beveling the edges of arrays 711 and 712, more light from the scintillator that falls in the gap is sensed by CCDs 721 and 722 than would be the case without beveled edges 731-732. Only pixels 0-2 in CCDs 721 and 722 do not receive light from scintillator 710.

Pixels in CCDs 721-722 receive light in the gap area from scintillator 710 with beveled edges 731-732. For example, without beveled edge 731 (e.g., like in FIG. 4), light in the gap from scintillator 710 would not be seen. With beveled edge 731, pixel 3 is fully illuminated with light in the gap from scintillator 710. Therefore, the embodiment of FIG. 7 can sense more light in between the fiber optic arrays than the embodiments of FIGS. 2A-2B, enabling the sensors to generate a more complete image.

The light that falls on beveled edges 731-732 near the gap between arrays 711-712 overlaps in the generated image. FIG. 8B illustrates a visualization of that overlap. The light packets j and l fall on beveled edges 731-732 and travel to CCDs 721-722 through optical fibers in arrays 711-712. Light packets j and l are sensed by pixels 3 in CCDs 722 and 721. Because light packets j and l fall on beveled edges 731-732, which are slanted at an angle, the sharpness of the image reproduced by pixels 3 is reduced. The reproduction of light packets j and l overlap as shown in FIG. 8B.

While some sharpness in the image at the seams between CCDs may be lost, the device of FIG. 7 provides a continuous image without any blind gaps or seams between the CCDs. A continuous image that does not have any seams is more desirable than an image with seams. The embodiment of FIG. 7 may also be applied to sensors with optical fibers that are perpendicular to the plane of the CCD sensors.

In a further embodiment of the present invention, the tapered optical fiber arrays shown in FIGS. 2B and 6 have beveled edges that pick up additional light from the scintillator. The beveled edges of this embodiment can look like beveled edges 731-732.

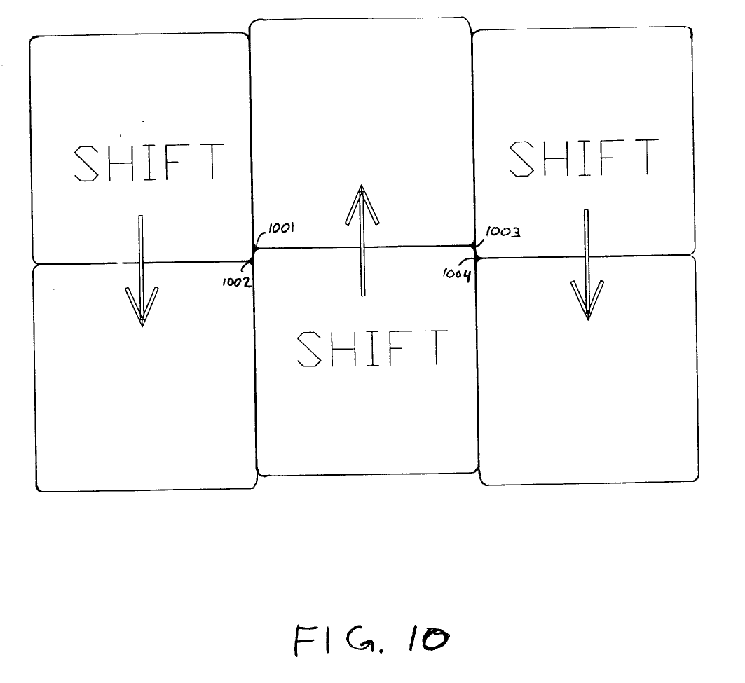

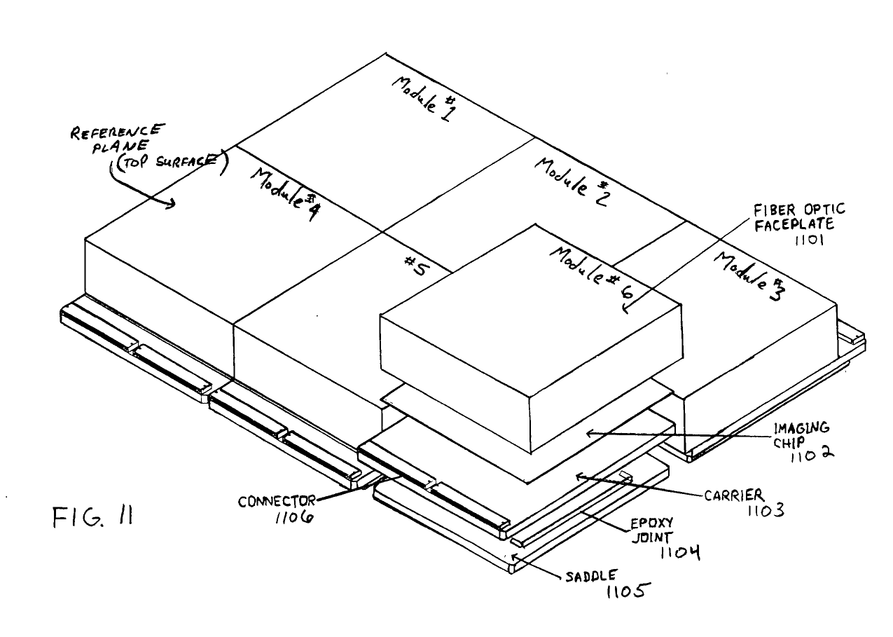

FIGS. 9A-9B illustrate another embodiment of the present invention. FIG. 9A illustrates a top down view of a portion of a tiled array of fiber optic arrays 911-914. Each of the fiber optic arrays is positioned in a quadrant of the array, with a gap between each fiber optic array. Because fiber optic arrays typically have rounded corners as shown in FIG. 9A, a large dead zone 920 is formed in the middle of the array. Dead zone 920 is surrounded by the edges of four fiber optic arrays 911-914.

The light that falls into dead zone 920 is not sensed by any of the CCDs associated with fiber optic arrays 911-914. Therefore, a sizable portion of the image is lost in the image generation process because of the large size of zone 920. The final generated image appears with a relatively large hole corresponding to the location of zone 920. A large image hole such as the hole caused by zone 920 is difficult to electronically correct.

FIG. 9B illustrates a technique in accordance with the present invention that reduces the size of dead zone 920. Fiber optic arrays 912 and 913 are shifted down, and/or fiber optic arrays 911 and 914 are shifted up so that the size of dead zone 920 is essentially reduced in half. Fiber optic arrays 911-914 are shifted enough so that dead zone 920 is split into two smaller dead zones 931 and 932. Dead zone 931 is only surrounded by fiber optic arrays 911, 912, and 914. Dead zone 932 is only surrounded by fiber optic arrays 914, 913, and 912.

Dead zones 931-932 also cause holes in the final generated image. However, the holes caused by dead zones 931-932 are half the size of the hole caused by dead zone 920. The small image holes caused by zones 931 and 932 are easier to correct using well know post-sensing electronic techniques.

FIG. 10 illustrates how a 2×3 array of six fiber optic arrays can be shifted to reduce the large dead zones between the fiber optic arrays. The sensor of FIG. 10 has four smaller dead zones 1001-1004. The techniques of present invention may be applied to fiber optic arrays of any size (M×N) to reduce the area of the dead zones. By applying the techniques of the present invention, dead zones 1001-1004 may be small enough so that the resulting image does not need to be corrected electronically, increasing the camera's speed and the image quality.

In the embodiments of FIGS. 9-10, the CCD sensors underneath the shifted fiber optic arrays may remain in a rectangular configuration as shown in FIG. 1. In a further embodiment, the CCD sensors underlying the fiber optic arrays can be shifted in the same directions as the fiber optic arrays to reduce dead zones between the CCDs. In this embodiment, the CCDs are positioned in the same configuration as the fiber optic arrays shown in FIG. 10.

One difficulty in manufacturing an array of tiled charge coupled devices involves the alignment of the fiber optic arrays. If the upper surfaces of the fiber optic arrays are not aligned in a flat, even plane, any unevenness in the upper surfaces of the arrays can cause the reproduced image to be distorted. However, it can be a difficult and tedious process to align the upper surfaces of the fiber optic arrays or the upper surfaces of the CCDs optically. It can also be difficult to remove and to replace a damaged CCD chip in a tiled CCD array.

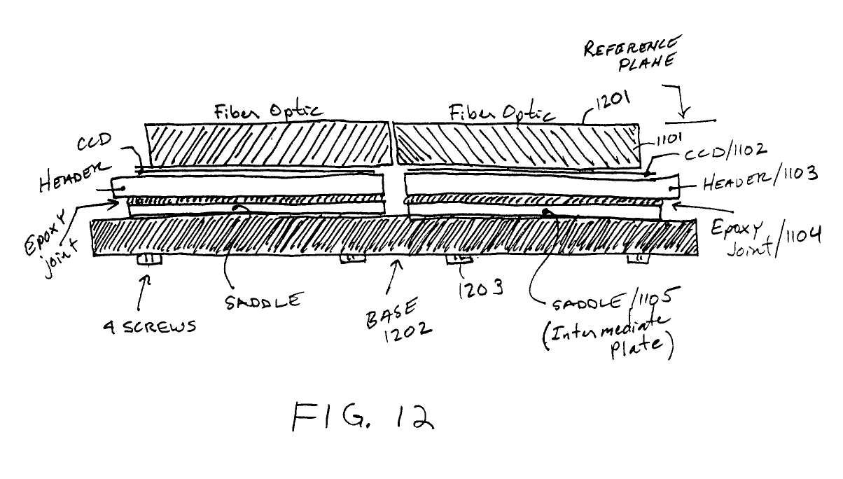

FIGS. 11-12 illustrate an embodiment of the present invention that makes it possible to manufacture a tiled CCD structure so that the upper surfaces of the fiber optic arrays are aligned in a flat, even reference plane. FIG. 11 illustrates an array of CCDs that are formed with an even reference plane in accordance with this embodiment of the present invention. The CCD array in FIG. 11 includes six CCDs that are arranged in a 2×3 array. One of the CCDs 1102 (imaging chip) is shown in FIG. 11.

The CCDs in the array are each attached to a header (also called a carrier). CCD 1102 is attached to carrier 1103. Each fiber optic array is attached to a corresponding CCD in the array (e.g., using clear epoxy). Fiber optic array (faceplate) 1101 is attached to CCD 1102 as shown in FIG. 11. The optical fibers in array 1101 may be angled to reduce the seams between CCD tiles as discussed above in the previous embodiments.

The assembly of FIGS. 11-12 also includes a saddle 1105 that is attached to each carrier 1103 through an epoxy joint 1104. Each carrier 1103 has a connector 1106 that connects to the output pins of the CCD chip 1102. The scintillator is not shown in FIGS. 11-12 for simplicity. The saddles 1105 are also referred to as intermediate plates.

By adding a fiber optic array to the top surface of each CCD in the array, the optical reference plane is shifted from the top surface of the CCDs to the top surface of the fiber optic arrays. Because the fibers in the fiber optical arrays project the image directly onto the CCD chips, the placement of the CCD chips does not effect the image quality. For example, the quality of the image is not adversely effected if the CCDs are tilted with respect to one another or are not aligned in the same plane.

The upper surface of each of the fiber optic arrays is aligned with respect to a reference plane (see FIG. 12). By aligning the fiber optic arrays with respect to the reference plane, the upper surfaces of the fiber optic arrays form a flat, even plane. The reference plane also removes any tilt between the upper surfaces of the fiber optic arrays.

An exemplary assembly process is as follows. The upper surfaces 1201 of the fiber optic arrays 1101 (FIG. 12) are placed face down on a surface that has a flat, even plane. This surface forms a common reference plane for the fiber optic arrays that keeps their upper surfaces 1201 on a flat, even plane. The upper surfaces of the CCDs (attached to the ceramic headers) are attached to the bottom surfaces of the fiber optic arrays.

The saddles 1105 are attached to a base unit 1202. For example, saddles 1105 can be screwed onto base 1202 using screws 1203. One saddle is screwed onto base 1202 for each CCD in the array.

Once the reference plane has been established for the CCDs and the fiber optic arrays, a layer of epoxy 1104 is applied evenly to the saddles 1105. The purpose of epoxy layer 1104 is to bond headers 1103 to saddles 1105. After epoxy layer 1104 is applied, base 1202 is flipped upside down (with respect to its orientation in FIG. 12), and saddles 1105 are glued onto headers 1103.

The thickness of epoxy layer 1104 can vary to accommodate any variation between the thickness and the planarity of the bottom surfaces of fiber optic arrays 1101. Once epoxy layer 1104 dries, the upper surfaces 1201 of the fiber optic arrays remain in a level, even plane, and the headers 1103 are securely bonded to the saddles 1105. The final structure is shown in FIG. 12.

A damaged CCD chip can be easily removed from the structure of FIG. 12, as will now be discussed. First, screws 1203 corresponding to the damaged CCD chip are removed. The damaged CCD chip along with its corresponding fiber optic array and saddle are then carefully lifted off base 1202 and removed from the CCD array. Once the defective CCD has been removed, a new CCD can be easily installed.

To install the new CCD module, a new saddle is first screwed onto base 1202 where the old saddle was removed. Then, an even amount of epoxy is applied to the saddle. However, the epoxy can travel into the spaces between the saddles before it dries causing the fiber optic array to fall below the reference plane. Spacers can be placed between saddles to prevent the epoxy from traveling into the spaces between the saddles, so that the replacement fiber optic array does not sink below the reference plane.

A new fiber optic array is attached to a new CCD and a new ceramic header. The new fiber optic array is then inverted so that its upper surface is placed on a reference plane. The base with the CCD array is then inverted, and the replacement saddle is gently placed on top of the new ceramic header. The upper surfaces 1201 of the old fiber optic arrays are placed on the same common reference plane as the new fiber optic array. When the epoxy hardens, the upper surface of the replacement fiber optic array aligns with the reference plane of the other fiber optic arrays in the assembly. The thickness of the epoxy layer varies to accommodate for any variations in the thickness and planarity of the replacement fiber optic array.

While the present invention has been described herein with reference to particular embodiments thereof, a latitude of modification, various changes, and substitutions are intended in the present invention. In some instances, features of the invention can be employed without a corresponding use of other features, without departing from the scope of the invention as set forth. Therefore, many modifications may be made to adapt a particular configuration or method disclosed, without departing from the essential scope and spirit of the present invention. It is intended that the invention not be limited to the particular embodiment disclosed, but that the invention will include all embodiments and equivalents falling within the scope of the claims.

What is claimed is:

1. An imaging device comprising:
charge coupled devices arranged in an M×N array; and
fiber optic arrays that each comprise a plurality of optical fibers, wherein at least a subset of the optical fibers receives electromagnetic radiation falling in between the charge coupled devices and transmits the electromagnetic radiation to the charge coupled devices.

2. The imaging device of claim 1 further comprising a scintillator that provides the electromagnetic radiation to each of the fiber optic arrays.

3. The imaging device of claim 1 wherein each of the charge coupled devices are attached to a ceramic header.

4. The imaging device of claim 1 wherein the charge coupled devices are arranged in a 2×2 array of four charge coupled devices.

5. The imaging device of claim 1 wherein the optical fibers within each of the fiber optic arrays are parallel to the other optical fibers in that fiber optic array.

6. The imaging device of claim 1 wherein the optical fibers at the outer edges of each of the fiber optic arrays fan out away from a center axis of each fiber optic array above the surface of each charge coupled device.

7. The imaging device of claim 6 wherein the optical fibers in each of the fiber optic arrays are linear.

8. The imaging device of claim 6 wherein the optical fibers in each of the fiber optic arrays are not linear.

9. The imaging device of claim 1 further comprising:
a plurality of horizontal shift registers that are coupled to receive signals from pixels in the charge coupled devices.

10. The imaging device of claim 9 wherein the horizontal shift registers or vertical summing wells sum together signals from a plurality of rows of the pixels from each of the charge coupled devices.

11. The imaging device of claim 10 further comprising:
a scintillator that provides the electromagnetic radiation to each of the fiber optic arrays;
horizontal summing wells that are each coupled to receive signals from the horizontal shift registers, each of the horizontal summing wells adding signals from a plurality of columns of the pixels from one of the charge coupled devices.

12. The imaging device of claim 11 wherein first columns of pixels in the charge coupled devices receive electromagnetic radiation from the scintillator through optical fibers that are exposed at the upper surfaces of the fiber optic arrays,
and second columns of the pixels are configured to receive electromagnetic radiation through optical fibers that are exposed along sides of the fiber optic arrays.

13. The imaging device of claim 11 wherein columns of pixels in the charge coupled devices receive electromagnetic radiation from the scintillator through optical fibers that are exposed at the upper surfaces or at beveled edges of the fiber optic arrays.

14. The imaging device of claim 11 wherein a signal from a first column of the pixels in a first channel of a first charge coupled device is added to a signal from a second column of the pixels in a second channel of the first charge coupled device, the pixels in the first and second columns receiving electromagnetic radiation from the scintillator.

15. A method for sensing electromagnetic radiation, the method comprising:
transmitting electromagnetic radiation through optical fibers to a plurality of charge coupled devices, at least a subset of the optical fibers being configured such that electromagnetic radiation falling between the charge coupled devices is transmitted through the subset of the optical fibers to the charge coupled devices; and
sensing the electromagnetic radiation transmitted through the optical fibers at the plurality of charge coupled devices.

16. The method of claim 15 further comprising:
receiving short wavelength radiation at the surface of a scintillator; and
converting the short wavelength radiation to provide longer wavelength electromagnetic radiation at exposed ends of the optical fibers.

17. The method of claim 16 wherein the optical fibers are grouped in a plurality of fiber optic arrays that have beveled edges, subsets of the optical fibers in the fiber optic arrays receiving electromagnetic radiation at the beveled edges that falls in between the charge coupled devices.

18. The method of claim 15 further comprising:
transferring image signals into vertical shift registers, wherein the image signals are generated by pixels in the charged coupled devices; and
summing together image signals from a plurality of rows and columns of the pixels.

19. The method of claim 18 wherein summing together the image signals further comprises summing together only the image signals from the pixels that receive an amount of electromagnetic radiation from the scintillator that exceeds a threshold level.

20. The method of claim 18 wherein a first subset of the pixels receive electromagnetic radiation from the scintillator through optical fibers that are exposed at upper surfaces of the fiber optic arrays, and
a second subset of the pixels receive electromagnetic radiation through optical fibers that are exposed along sides of the fiber optic arrays.

21. The method of claim 15 wherein the optical fibers are grouped in a plurality of fiber optic arrays, and the optical fibers at edges of each of the fiber optic arrays fan out from a center axis of each fiber optic array above the surface of each charge coupled device.

22. The method of claim 21 wherein the optical fibers in each of the fiber optic arrays are linear.

23. The method of claim 21 wherein the optical fibers at the edges of the fiber optic arrays bend away from the center axis of each fiber optic array above the surface of each charge coupled device.

24. The method of claim 15 wherein the plurality of charge coupled devices includes four charge coupled devices arranged in a 2×2 array.

25. The method of claim 24 wherein the plurality of charge coupled devices includes six charge coupled devices arranged in a 2×3 array.

26. A method for processing signals from a charge coupled device, the method comprising:
receiving first signals from first pixels that receive electromagnetic radiation from first optical fibers, wherein the first optical fibers map to a side of a fiber optic array;
receiving second signals from second pixels that receive electromagnetic radiation from second optical fibers, wherein the second optical fibers map to an upper surface of the fiber optic array;
discarding the first signals; and
using the second signals to produce an image indicative of the electromagnetic radiation.

27. A method for processing signals from a first charge coupled device, the method comprising:
receiving first signals from first pixels in the first charge coupled device, the first pixels being in a first channel of the first charge coupled device;
receiving second signals from second pixels in the first charge coupled device, the second pixels being in a second channel of the first charge coupled device;
adding a subset of the first signals to a subset of the second signals to obtain a third signal; and
using the first signals, the second signals, and the third signal to produce an image.

28. The method of claim 27 further comprising:
receiving fourth signals from fourth pixels in a second charge coupled device, wherein the second charge coupled device is adjacent to the second channel of the first charge coupled device;
adding a subset of the fourth signals to a subset of the second signals to obtain a fifth signal; and
using the fourth signals and the fifth signal to produce the image.

29. An imaging device comprising:
an array of at least four charge coupled devices, each of the charge coupled devices being adjacent to at least two of the other charge coupled devices;
fiber optic arrays comprising optical fibers, each one of the fiber optic arrays being placed over one of the charge coupled devices;
a wherein a first gap is formed between edges of only a first, a second, and a third of the fiber optic arrays; and
wherein a second gap is formed between edges of only the second, the third, and a fourth of the fiber optic arrays.

30. A method for forming an image sensor system, the method comprising:
attaching first surfaces of a plurality of fiber optic arrays to a plurality of charge coupled devices, each of the charge coupled devices being attached to a carrier;
placing second surfaces of the plurality of fiber optic arrays on a common reference plane;
attaching a plurality of intermediate plates to a base; and
gluing each of the carriers to one of the intermediate plates while the second surfaces of the plurality of fiber optic arrays are on the common reference plane.

31. The method of claim 30 wherein gluing each of the carriers to one of the intermediate plates comprises using epoxy to glue the carriers to the intermediate plates.

32. The method of claim 30 further comprising:
transmitting electromagnetic radiation through optical fibers in the fiber optic arrays to the plurality of charge coupled devices, at least a subset of the optical fibers being configured such that electromagnetic radiation falling in between the charge coupled devices is transmitted through the subset of the optical fibers to the charge coupled devices.

33. The method of claim 30 wherein attaching a plurality of intermediate plates to a base comprises screwing the intermediate plates to the base.

34. The method of claim 30 further comprising:
detaching a first one the intermediate plates from the base;
removing one of the charge coupled devices and one of the fiber optic arrays that are attached to the first intermediate plate;
attaching a second intermediate plate to the base in place of the first intermediate plate;
placing a first surface of a new fiber optic array on a reference plane, a second surface of the new fiber optic array being attached to a new charge coupled device that is attached to a new carrier; and
gluing the new carrier to the second intermediate plate.

35. The method of claim 30 wherein attaching first surfaces of a plurality of fiber optic arrays to a plurality of charge coupled devices further comprises attaching first surfaces of four fiber optic arrays to four charge coupled devices, and
wherein gluing each of the carriers to one of the intermediate plates further comprises gluing each of four carriers to four corresponding intermediate plate to form a 2×2 array of the charge coupled devices.
